(19) United States
(12) Patent Application Publication
(10) Pub. No.: US 2010/0230451 A1
(43) Pub. Date: Sep. 16, 2010

(54) ROOF BAR FOR A MOTOR VEHICLE

(75) Inventors: Torsten Gerhardt, London (GB); John K. Harding, Leigh-on-Sea (GB); Steve David Fleming, Hockley (GB); Danny Edward Stanesby, Benfleet (GB); Alicia Agius, Romford (GB); Will Farrelly, Chelmsford (GB)

Correspondence Address: Jerome R. Drouillard, 10213 Tims Lake Blvd., Grass Lake, MI, 49240, US

(73) Assignee: FORD GLOBAL TECHNOLOGIES, LLC, Dearborn, MI (US)

(21) Appl. No.: 12/403,559

(22) Filed: Mar. 13, 2009

(51) Int. Cl. B60R 9/045; B60R 9/052

(52) U.S. Cl. 224/321; 224/322; 280/769

(57) ABSTRACT

A roof bar (10) for a motor vehicle (1) is disclosed in which an elongate load carrying member (313) is selectively held in a deployed position by a latch mechanism (320). The latch mechanism (320) interacts directly with the elongate load carrying member (313) and no separate stay is required to hold the elongate load carrying member (313) in the deployed position. The components (311, 315, 316) forming the roof bar (10) are all relatively thin when the roof bar (10) is in the stowed state, so as to minimize any change in vehicle height.

### CROSS REFERENCE TO RELATED APPLICATIONS

None.

### BACKGROUND OF THE INVENTION

1. Field of the Invention

This invention relates to a motor vehicle, and in particular to a roof bar for carrying a load on a roof of the motor vehicle.

2. Related Art

It is known to provide a motor vehicle with two or more removable roof bars in order to carry objects on the roof of a motor vehicle such as, for example, a roof box, a ladder, scaffold poles, scaffold planks and long lengths of timber. It is a problem with a removable roof bar that considerable time and effort is required to fit or remove the roof bar from the vehicle.

It is a further problem that such fixed but removable roof bars greatly increase the height of the vehicle when they are fitted and, as such, removable roof bars are not ideal for use on a light commercial vehicle such as a van where it is desirable to keep the height of the vehicle below the height restrictions commonly imposed at car park entrances when no load is to be carried on the roof.

It would be an advantage to provide a stowable roof bar for a motor vehicle that is quick and easy to deploy and stow and which does not significantly increase the overall height of the vehicle when it is stowed.

### SUMMARY OF THE INVENTION

According to a first aspect of the invention there is provided a stowable roof bar for a motor vehicle comprising an elongate load carrying member pivotally connected to a roof of the vehicle so as to extend across the vehicle and a latch mechanism to selectively hold the elongate load carrying member in a deployed state in which a crossbar portion of the elongate load carrying member is spaced above the roof of the vehicle. The latch mechanism includes a first member having two surfaces corresponding to the stowed and deployed positions of the roof bar attached to one of the vehicle roof and the elongate load carrying member, and a complimentary surface on the other of the vehicle roof and the elongate load carrying member for engagement with one of the two surfaces so as to secure the roof bar in the first position corresponding to the stowed state of the roof bar and with the other of the two surfaces so as to secure the roof bar in the second position corresponding to the deployed state of the roof bar.

The invention has the advantage that a separate stay or strut is not required to hold the roof bar in its deployed position, thereby reducing the weight and cost of the roof bar.

The first member is a polygonal member having an even number of sides attached to one of the vehicle roof and the elongate load carrying member, and a complimentary surface on the other of the vehicle roof and the elongate load carrying member for engagement with one or more of the sides so as to secure the roof bar in at least a first position corresponding to the stowed state of the roof bar and a second position corresponding to a deployed state of the roof bar.

The polygonal member may be attached to one of a bracket on the vehicle roof and the elongate load carrying member and the complimentary surface is one surface of a polygonal aperture formed in one of the elongate load carrying member and the bracket wherein the polygonal aperture is engageable with the polygonal member in at least a first position corresponding to the stowed state of the roof bar and a second position corresponding to a deployed state of the roof bar.

The polygonal member may be a peg extending from the bracket and the elongate load carrying member has the complimentary polygonal aperture formed therein.

The elongate load carrying member may comprise a crossbar portion which extends across the motor vehicle and two end portions, one at each end of the crossbar portion, and the aperture is formed in at least one of the two end portions.

The elongate load carrying member may be H-shaped.

Advantageously, the crossbar portion may be asymmetrical in cross-section, having a thickness that is considerably less than the width of the crossbar portion so as to minimize the increase in vehicle height when the roof bar is stowed while retaining a high resistance to bending when a load is carried on the roof bar in the deployed position.

The thickness of the elongate load carrying member may be such that, when the latch mechanism is released so as to permit the roof bar to be moved to a stowed state in which the elongate load carrying member is folded flat on the roof of the vehicle, the highest point of the stowed roof bar is lower than a high point on the roof of the motor vehicle so that the overall height of the vehicle is not increased.

There may be an aperture in both of the end portions and two pegs are provided one for co-operation with each peg, both of the pegs extending in the same direction away from their respective brackets.

Each peg has a round portion that acts as a guide means during transit between the stowed and deployed states and a polygonal portion for latching the elongate load carrying member in the stowed and deployed positions.

The polygonal aperture may be a square aperture.

The polygonal member may be a square member.

Alternatively, the complimentary surface may be a surface on a clamping member that is engageable with the polygonal member.

The roof of the motor vehicle may have a high point and a low point and the roof bar is fitted so as to be stowable in a open ended transverse channel in the roof of the vehicle and the thickness of the components forming the roof bar may be such that, when the roof bar is moved to a stowed state, no part of the stowed roof bar is located below the low point of the roof and above the high point of the roof.

The roof bar may further include a locking means to hold the latching means in a latched position.

Advantageously, the locking means is releasable from one end of the roof bar.

According to a second aspect of the invention there is provided a motor vehicle having a roof and at least two roof bars constructed in accordance with said first aspect of the invention attached to the roof of the motor vehicle in a spaced apart relationship.

The roof of the motor vehicle may have a high point and a low point corresponding to a height below which a surface is not self draining and a number of transverse open ended channels each sized to accommodate a stowed roof bar, each of the channels having a base surface located no lower than the low point of the roof such that, when each roof bar fitted to the roof of the vehicle is moved to its respective stowed state, no part of the stowed roof bar is located higher than the high point of the roof so that the overall height of the motor vehicle is not increased by the stowed roof bars and no part of each roof bar is located lower than the low point of the roof.

The roof may have a convex central portion bounded on each side by a longitudinally extending drainage ditch and the low point of the roof corresponds to the height of the drainage ditches.

Each of the channels may have a base surface located no lower than the height of the drainage ditches so as to ensure that it is self draining.

### BRIEF DESCRIPTION OF THE DRAWINGS

FIG. 1 is a side view of a motor vehicle according to the invention;

FIG. 2 is rear view of the motor vehicle shown in FIG. 1;

FIG. 3a is a pictorial schematic view of a roof of the vehicle shown in FIGS. 1 and 2 showing two transverse open ended channels and a roof bar according to the invention in deployed and stowed states;

FIG. 3b is a pictorial view of the right hand side of the roof shown in FIG. 3 but with no roof bars in place;

FIG. 4a is a partial transverse cross sectional view of the roof shown in FIG. 3b in which the dimensions and curvature have been greatly exaggerated;

FIG. 4b is a view similar to that of FIG. 4a showing a possible stowage volume for a roof bar according to one aspect of the invention;

FIG. 5a is a pictorial view of a left hand end of a roof bar according to the invention showing the roof bar in a stowed state;

FIG. 5b is an enlarged view of part of a right hand end of the roof bar shown in FIG. 5a;

FIG. 6a is a pictorial view of the left hand end of the roof bar shown in FIG. 26a showing the roof bar in a partially deployed state;

FIG. 6b is an enlarged view of part of a right hand end of the roof bar shown in FIG. 6a;

FIG. 7 is a pictorial view of the left hand end of the roof bar shown in FIGS. 5a and 6a showing the roof bar in a deployed state;

FIG. 8 is a pictorial representation showing the full roof bar in a deployed position;

FIG. 9a is a pictorial view showing part of a locking device for the roof bar;

FIG. 9b is a partial cross-section showing more parts of the locking device; and

FIG. 9c is a pictorial view of a quarter turn lever for the locking device shown in FIGS. 9a and 9b.

### DETAILED DESCRIPTION OF THE PREFERRED EMBODIMENTS

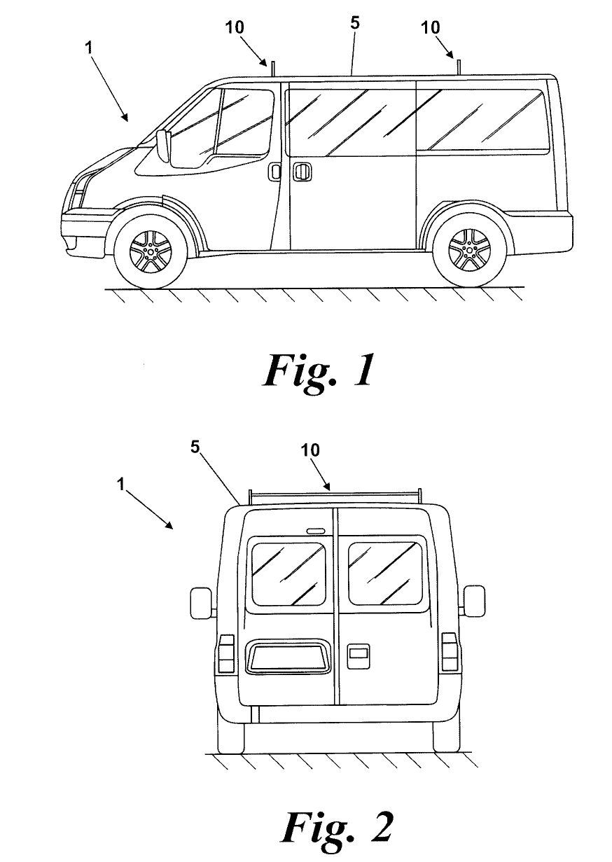

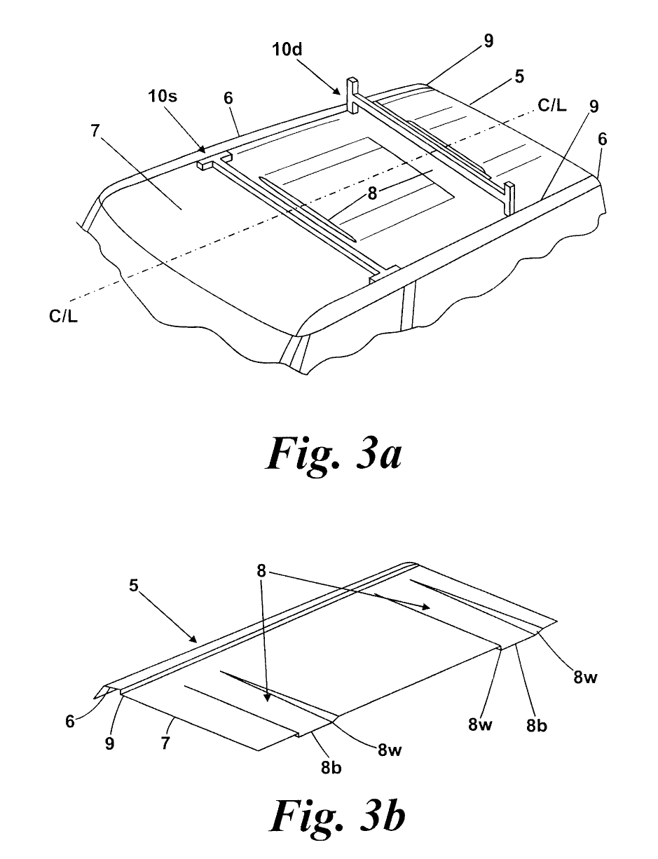

With particular reference to FIGS. 1 to 4b there is shown a motor vehicle, 1, having a roof, 5, upon which is mounted two spaced apart identical stowable roof bars 10.

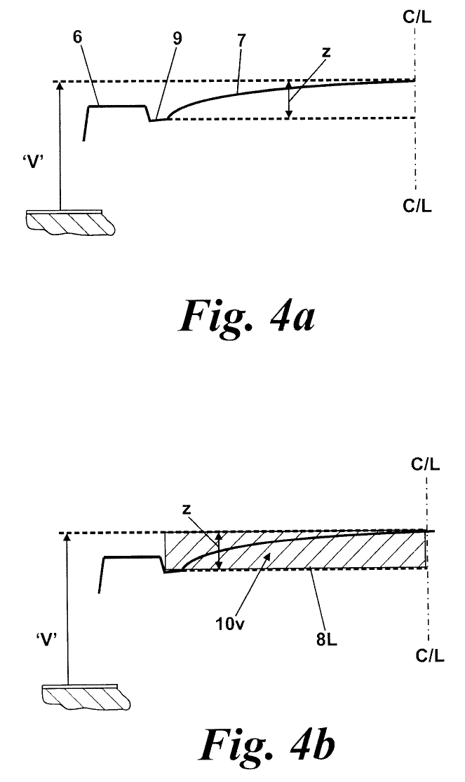

Each of roof bars 10 is reversibly moveable between a stowed state, indicated by the reference numeral 10s on FIG. 3, to a deployed state, indicated by the reference numeral 10d on FIG. 3, where it is retainable by a latch mechanism.

In FIGS. 1 to 3a the motor vehicle 1 is in the form of a van and is shown with two roof bars 10 fitted to its roof 5, but it will be appreciated that more than two roof bars 10 could be fitted to the roof 5.

Roof 5 comprises of a convex central portion, 7, bounded on each longitudinal side by a drainage ditch, 9, two channels, 8, with each having sides surfaces, 8w, and a base surface, 8b, and a ridge, 6, running longitudinally along both outer edges of roof 5.

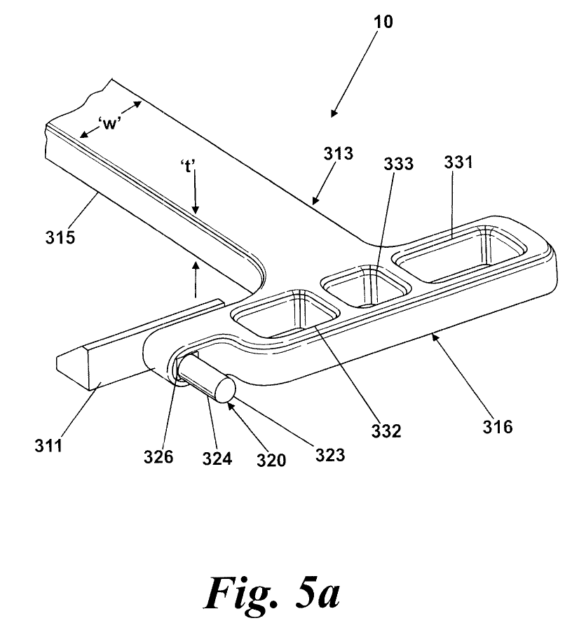

Referring now to FIGS. 4a and 4b, central roof portion 7 has a high point or crown located on the centre line, C/L, of motor vehicle 1 and, in this case, this is also the highest point of vehicle 1 and so defines the overall height ‘V’ of vehicle 1. It will, however, be appreciated that with some roof forms the height of the ridges, 6, may determine the overall height of vehicle 1.

In the case where the high point is determined by the height of ridges 6, there will be a difference in height between the high point of central roof portion 7 and the highest point of vehicle 1, and this difference in height may be sufficient in some cases to package a stowed roof bar in accordance with this invention. However, in most cases, this difference will not be sufficient to permit a stowed roof bar to be stowed without increasing the vehicle height.

If, as shown, ridges 6 are lower than the overall height ‘V’ of the vehicle as determined by the high point of central roof portion 7 a number of channels 8 must be formed in central roof portion 7 so as to provide sufficient volume in which to stow each roof bar 10 so that, when roof bars 10 fitted to the roof of the vehicle 1 are moved to their respective stowed states, no part of the stowed roof bars 1 is located higher than the high point of roof 5, so that the overall height ‘V’ of the vehicle 1 is not increased by the stowed roof bars 10. Such channels could also be used even if the high point is the ridges, to provide an increased volume for stowing roof bar 10.

Roof 5 has a low point corresponding to a height below which a surface is not self draining, and each roof bar 10 must be stowed on a surface that is no lower than the low point of roof 5 so that the surface is self draining and to reduce drag, wind noise and improve the aesthetic appearance of the vehicle.

As the low point of roof 5 corresponds to the height of the drainage ditches 9, each of channels 8 must have a base surface 8b located no lower than the height of the drainage ditches 9 so as to ensure that the channels 8 are self draining.

In FIGS. 4a and 4b, the dimension z represents the vertical height between the level of the drainage ditches 9 and the high point of the roof 5 and it is this space that can be utilized by incorporating the channels 8 into the roof 5 to stow a roof bar 10. FIG. 4b shows as a shaded area 10v the volume that can be occupied by a stowed roof bar 10 without increasing the overall height ‘V’ of the vehicle 1. The line 8L corresponds to the minimum height of the base surface 8b that must be maintained if the corresponding channel 8 is to be self draining.

Therefore although a roof bar formed in accordance with this invention can be used on many types of roof depending upon their respective configuration and is not limited to a roof having the profile shown, it is desirable for the roof 5 to have a number of open ended channels 8 because these can be used to assist with stowage of the roof bars 10 by providing an additional stowage volume.

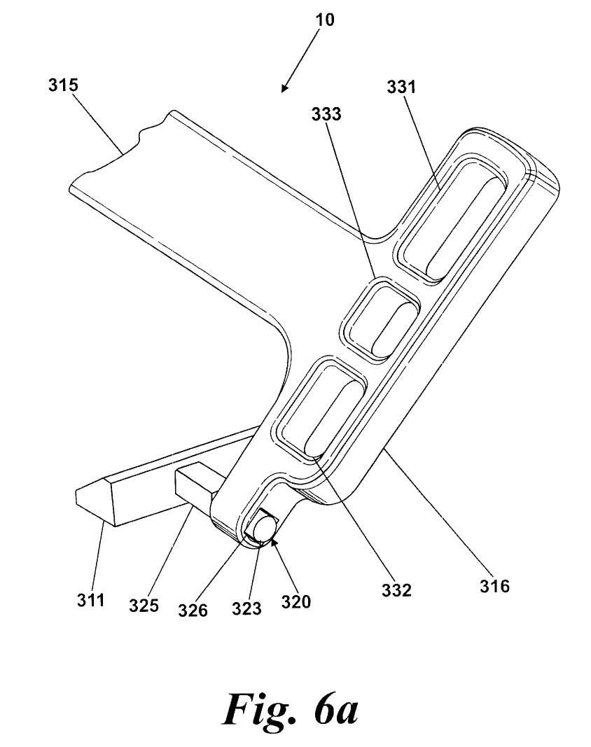

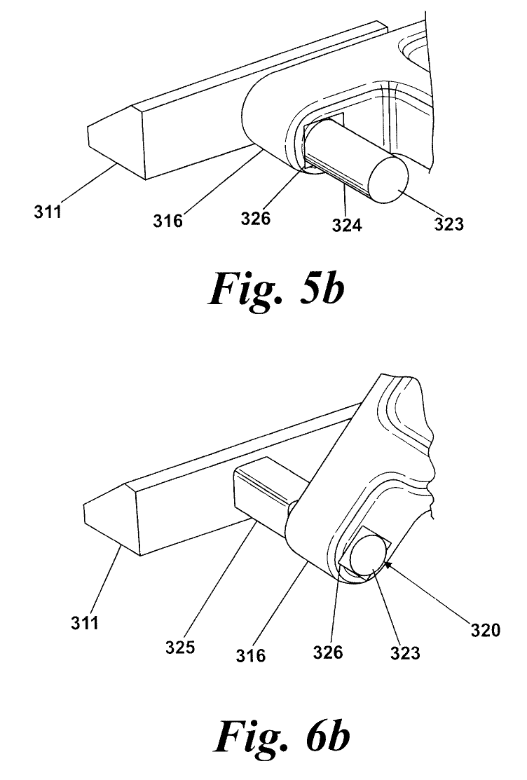

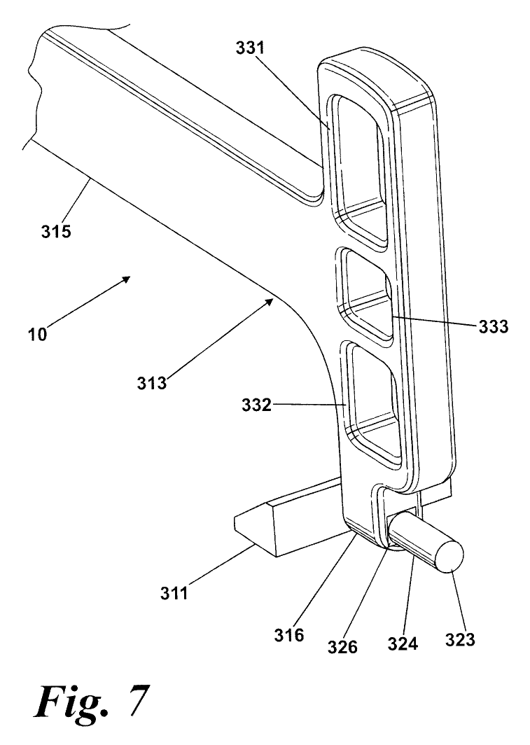

With reference to FIGS. 5a to 10 there is shown in greater detail the roof bar 10.

Roof bar 10 includes an elongate load carrying member, 313, pivotally connected to the roof of vehicle 1 so as to extend across vehicle 1, and a latch mechanism, 320, to selectively latch the elongate load carrying member 313 so as to hold the elongate load carrying member 313 in a deployed state in which a crossbar portion 315 of the elongate load carrying member 313 is spaced above the roof of vehicle 1. Elongate load carrying member 313 is H-shaped and includes crossbar portion 315 and two end portions, 316, one fastened to each end of crossbar portion 315.

End portions 316 are used to space the crossbar 315 above the roof when the roof bar 10 is in the deployed state and provide end stops for the crossbar 315 so as to prevent an item secured to the roof bar 10 from sliding off either end of the crossbar 315.

Crossbar 315 is formed from a rectangular tube that is wide relative to its thickness so that, when the cross bar 315 is in the deployed state, the crossbar 315 is able to support a load fastened to the roof bar 10 but, when the roof bar 10 is stowed, the thickness of the crossbar 315 is such that the overall height of the vehicle 1 is not increased by the stowed roof bar 10. This asymmetric shape also has the advantage that the resistance to bending of the crossbar portion 315 is higher than it would be if the crossbar portion 315 was of the same width (w) as thickness (t) because of the increased second moment of area of the crossbar portion 315 when in the deployed position. The width (w) may for example be 1.5 to 4.0 times greater than the thickness (t) and the thickness may be in the range of 15 to 20 mm. Therefore the use of an asymmetrical shape provides a roof bar 10 able to support heavy loads while stowing in a relative small space above roof 5.

Each of end portions 316 is moulded from a plastic material and has a spigot (not shown) extending therefrom. Crossbar 315 has a bore shaped and sized to fit the spigots and the two end portions 316 are fastened to crossbar 315 by means of the spigots by, in this case, adhesive bonding.

Each end portion 316 also has three large apertures 331, 332, 333 formed therein for securing a load to roof bar 10 when roof bar 10 is in use.

Roof bar 10 further includes of a pair of base plates or brackets, 311, which are used to fasten the elongate load carrying member, 313, of roof bar 10 to roof 5. Each of base plates 311 has one of the two end portions 316 pivotally connected to it by means of a peg, 323. Each of pegs 323 has a round portion, 324, that acts as a guide means during transit of the elongate load carrying member 313 between the stowed and deployed states, and a polygonal portion, 325, for latching the elongate load carrying member 313 in the stowed and deployed positions. Polygonal portion 325 has an even number of sides and, in this case, has four sides so that the polygonal portion is a square member, 324. It will, however, be appreciated that, provided that a predetermined or indexed rotation of substantially 90 degrees is obtainable, a different number of sides could be used on the peg 323.

Each elongate load carrying member 313 has a complimentary polygonal aperture formed therein which in this case is a square aperture, 326. It will however be appreciated that a different number of sides could be used for the aperture 326 provided that the predetermined or indexed rotation is obtainable in conjunction with the cooperating peg 323.

It will be appreciated that an aperture, 326, is provided in both of the end portions 316 and that two pegs 323 are provided, one for co-operation with each peg 323. It will also be appreciated that both of the pegs 323 extend in the same direction away from their respective base plates 311.

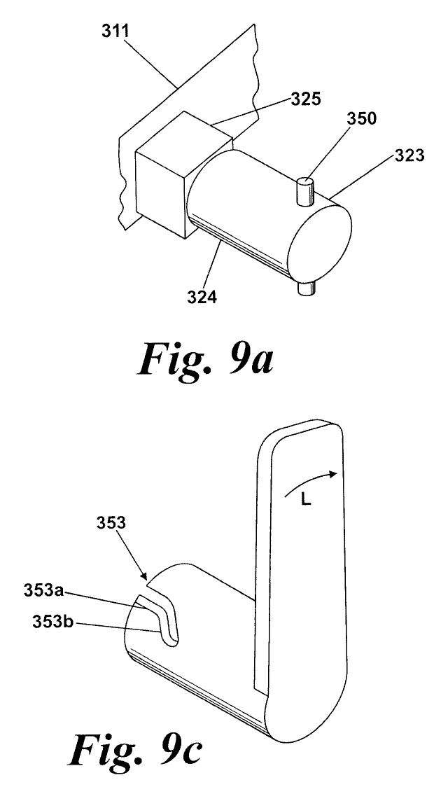

A locking means (shown in FIGS. 9a to 10) is used to lock one of the end portions 316 in at least the deployed position so as to prevent it from disengaging from the square portion 325 of the peg 323 if a side load is applied to the load carrying elongate member 313 of the roof bar 10 by a load carried thereon. The locking means may also be used to lock the end portions 316 in the stowed position.

The locking means comprises in this case, a pin, 350, press fitted in an aperture in the round portion 324 of one of pegs 323. A spring in the form of a belleville washer 351 is provided to bias the end portion 316 away from the base plate 311, and a quarter turn handle 352 is provided for engagement with pin 350.

Quarter turn handle 352 has a pair of L-shaped slots, 353, formed therein which engage with opposite ends of pin 350. L-shaped slots 353 have a first portion, 353a, aligned with a longitudinal axis of peg 323, and a second portion, 353b, inclined relative to the longitudinal axis of peg 323 so as to produce a clamping action when handle 352 is rotated in the direction of the arrow “L” on FIG. 10. As handle 352 is drawn towards base plate 311, spring 351 is compressed and the respective end portion 316 is clamped between handle 352 and base plate 311 on the square portion 325 of the peg 323. In this case, only one locking means is used for roof bar 10 because this permits roof bar 10 to be stowed and deployed from one end.

It will be appreciated that the locking means shown is only one of many types that could be used and that with some types of locking means these may be used at both ends of the elongate load carrying member 313. However, if two locking means are used, it is preferable for these to be interconnected so that they can both be released from one side of the vehicle 1.

The height of roof bar 10 when stowed is determined by the largest of the height of base plates 311, the thickness of end portions 316 of roof bar 10, and the thickness of crossbar portion 315. As discussed above, this dimension can be made as small as 15 to 20 mm without sacrificing the mechanical integrity of roof bar 10 if an asymmetric crossbar portion 315 is used.

Base plates 311 can be secured in drainage ditches 9 of roof 5 and, when stowed, crossbar 315 rests upon lower surface 8b of one of channels 8. However, it will be appreciated that roof bar 10 could be fastened to roof 5 so that it lies entirely within one of channels 8, or if there are no channels, directly to any convenient location on roof 5.

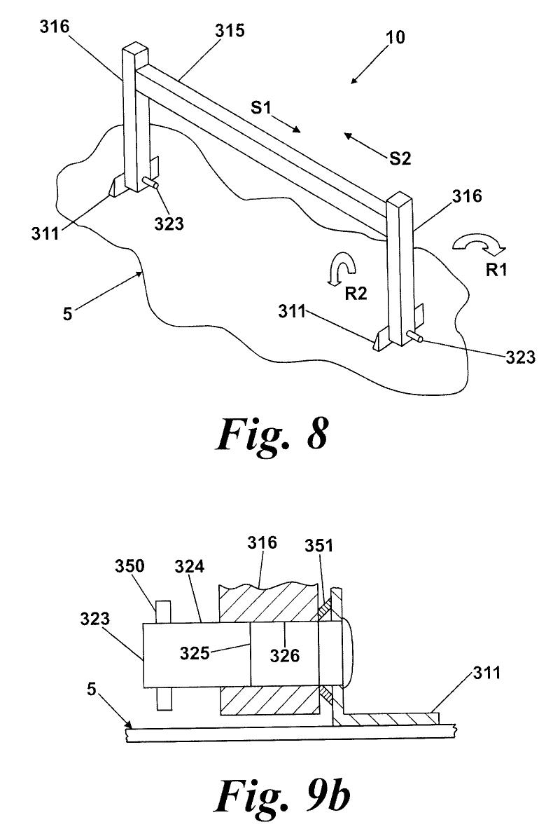

In operation, roof bar 10 can be moved from its deployed position, in which an upper surface of crossbar 315 is positioned approximately 100 to 200 mm above the adjacent central roof portion 7, to the stowed state, in which it is folded flat on the roof 5, by rotating locking handle 352 so as to release the locking means holding end portion 316 on the respective square portion 325 of the respective peg 323, axially displacing elongate load carrying member 313 in the direction of the arrow “S1” on FIG. 8 by pushing or pulling elongate load carrying member 313 so as to disengage square apertures 326 from square portions 325 of pegs 323, rotating elongate load carrying member 313 in the direction of arrow “R1” on FIG. 8 using round portions 324 of pegs 323 as guides or bearings and one of end portions 316 as a handle to its stowed position and then re-engaging square apertures 326 in end portions 316 with square portions 325 of pegs 323 by sliding it in the direction of arrow “S2”, and then re-applying locking handle 352 and rotating it to hold end portion 316 in place.

To reverse the procedure, locking handle 352 is removed, elongate load carrying member 313 is pushed or pulled in the direction of arrow “S1” so as to disengage square apertures 326 from square portions 325 of pegs 323. Elongate load carrying member 313 is then rotated in the direction of the arrow “R2” on FIG. 8 using round portions 324 of pegs 323 as guides or bearings, and one of end portions 316 as a handle to its deployed position. Square apertures 326 in end portions 316 are then re-engaged with square portions 325 of pegs 323 by sliding roof bar 10 in the direction of the arrow “S2” on FIG. 8, and finally locking handle 352 is replaced to clamp end portion 316 on square portion 325 of peg 323.

Although the invention has been described with respect to a specific embodiment having square pegs and square apertures it will be appreciated that it is not limited to such an embodiment. The latch mechanism for example could comprise a first member having two surfaces corresponding to the stowed and deployed positions of the roof bar attached to one of the vehicle roof and the elongate load carrying member and a complimentary surface on the other of the vehicle roof and the elongate load carrying member for engagement with the two surfaces so as to secure the roof bar in at least a first position corresponding to the stowed state of the roof bar and a second position corresponding to a deployed state of the roof bar. Alternatively, the latch mechanism could comprise a polygonal member having an even number of sides attached to one of the vehicle roof and the elongate load carrying member, and a complimentary surface for engagement with one or more of the sides, so as to secure the roof bar in at least a first position corresponding to the stowed state of the roof bar and a second position corresponding to a deployed state of the roof bar. The complimentary surface could be a surface on a clamping member that is engageable with the polygonal member, such as for example, a plate moveable into contact with one of the sides of the polygonal member and locked against the respective side by a rotary cam.

Similarly, it will be appreciated the polygonal member could alternatively be attached to the elongate load carrying member and the complimentary surface could be one surface of a polygonal aperture formed in the bracket.

It will also be appreciated that instead of the polygonal member being a pair of pegs 323 each extending from a respective base plate or bracket 311, the polygonal member could be part of a single elongate member extending from a bracket 311 at one end of elongate load carrying member 313 to a bracket 311 at the other end of elongate load carrying member 313.

It will be appreciated by those skilled in the art that although the invention has been described by way of example with reference to one or more embodiments, it is not limited to the disclosed embodiments and that one or more modifications to the disclosed embodiments or alternative embodiments could be constructed without departing from the scope of the invention as set out in the appended claims.

What is claimed is:

1. A stowable roof bar (10) for a motor vehicle (1) comprising an elongate load carrying member (313) pivotally connected to a roof (5) of the vehicle (1) so as to extend across the vehicle (1) and a latch mechanism to selectively hold the elongate load carrying member (313) in a deployed state in which a crossbar portion (315) of the elongate load carrying member (313) is spaced above the roof (5) of the vehicle (1) wherein the latch mechanism comprises a first member (323) having two surfaces corresponding to the stowed and deployed positions of the roof bar (10) attached to one of the vehicle roof (5) and the elongate load carrying member (313) and a complimentary surface (326) on the other of the vehicle roof (5) and the elongate load carrying member (313) for engagement with one of the two surfaces so as to secure the roof bar (10) in a first position corresponding to the stowed state of the roof bar (10) and with the other of the two surfaces so as to secure the roof bar (10) in a second position corresponding to a deployed state of the roof bar (10).

2. A roof bar (10) as claimed in claim 1 wherein the first member is a polygonal member (323) having an even number of sides attached to one of the vehicle roof (5) and the elongate load carrying member (313) and a complimentary surface (326) on the other of the vehicle roof (5) and the elongate load carrying member (313) for engagement with one or more of the sides so as to secure the roof bar (10) in at least the first position corresponding to the stowed state of the roof bar (10) and the second position corresponding to the deployed state of the roof bar.

3. A roof bar as claimed in claim 2 wherein the polygonal member (323) is attached to one of a bracket (311) on the vehicle roof (5) and the elongate load carrying member (313), and the complimentary surface is one surface of a polygonal aperture (326) formed in one of the elongate load carrying member (313) and the bracket (311) wherein the polygonal aperture (326) is engageable with the polygonal member (323) in at least a first position corresponding to the stowed state of the roof bar (10) and a second position corresponding to a deployed state of the roof bar (10).

4. A roof bar as claimed in claim 3 wherein the polygonal member is a peg (323) extending from the bracket (311) and the elongate load carrying member (313) has the complimentary polygonal aperture (326) formed therein.

5. A roof bar as claimed in claim 4 wherein the elongate load carrying member (313) comprises a crossbar portion (315) which extends across the motor vehicle (1) and two end portions (316), one at each end of the crossbar portion (315), and the aperture (326) is formed in at least one of the two end portions (316).

6. A roof bar as claimed in claim 5 wherein there is aperture in both of the end portions (316) and two pegs (323) are provided, one for co-operation with each peg (323), both of the pegs (323) extending in the same direction away from their respective brackets (311).

7. A roof bar as claimed in claim 4 wherein each peg (323) has a round portion (324) that acts as a guide means during transit between the stowed and deployed states and a polygonal portion (325) for latching the elongate load carrying member (313) in the stowed and deployed positions.

8. A roof bar as claimed in claim 2 wherein the polygonal aperture is a square aperture (326).

9. A roof bar as claimed in claim 2 wherein the polygonal member is a square member (325).

10. A roof bar as claimed in claim 2 wherein the complimentary surface is a surface on a clamping member that is engageable with the polygonal member.

11. A roof bar as claimed in claim 1 in which the roof (5) of the motor vehicle (1) has a high point and a low point and the roof bar (10) is fitted so as to be stowable in a open ended transverse channel (8) in the roof (5) of the vehicle (1) wherein the thickness of the components (311, 315, 316) forming the roof bar (10) are such that, when the roof bar (10) is moved to a stowed state, no part of the stowed roof bar (10) is located below the low point of the roof (5) and above the high point of the roof (5).

12. A motor vehicle (1) having a roof and at least two roof bars (10), as claimed in claim 1, attached to a roof (5) of the motor vehicle (1) in a spaced apart relationship.

13. A motor vehicle as claimed in claim 12 wherein the roof (5) of the motor vehicle (1) has a high point and a low point corresponding to a height below which a surface is not self draining and a number of transverse open ended channels (8) each sized to accommodate a stowed roof bar (10), each of the channels (8) having a base surface (8b) located no lower than the low point of the roof (5) such that, when each roof bar (10) fitted to the roof (5) of the vehicle (1) is moved to its respective stowed state, no part of the stowed roof bar (10) is located higher than the high point of the roof (5) so that the overall height of the motor vehicle (1) is not increased by the stowed roof bars (10) and no part of each roof bar (10) is located lower than the low point of the roof (5).

14. A motor vehicle as claimed in claim 13 wherein the roof has a convex central portion (7) bounded on each side by a longitudinally extending drainage ditch (9) and the low point of the roof (5) corresponds to the height of the drainage ditches (9).

15. A motor vehicle as claimed in claim 14 wherein each of the channels (8) has a base surface (8b) located no lower than the height of the drainage ditches (9) so as to ensure that it is self draining.
